(19) United States
(12) Patent Application Publication
(10) Pub. No.: US 2026/0016948 A1
(43) Pub. Date: Jan. 15, 2026

(54) SYSTEMS AND METHODS FOR MORPHABLE CHAT INPUT WITH DRAG-TO-PRIVATE AND DRAG-TO-EDIT INTERACTIONS

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/333,139

(22) Filed: Sep. 18, 2025

Related U.S. Application Data
(63) Continuation-in-part of application No. 19/182,453, filed on Apr. 17, 2025.
Application No. 19/182,453 is a continuation-in-part of application No. 18/135,703, filed on Apr. 17, 2023, now Pat. No. 12,393,433.
(60) Provisional application No. 63/332,205, filed on Apr. 18, 2022.

(51) Int. Cl. G06F 3/0486; G06F 3/01; G06F 3/04845; H04L 51/224

(52) U.S. Cl. CPC G06F 3/0486; G06F 3/017; G06F 3/04845; H04L 51/224

(57) ABSTRACT

A computer-implemented system and method provide context-preserving private messaging and inline editing within a conversational user interface. A client device renders a chat interface including a message timeline, participant indicators, and a morphable input box. A gesture recognizer detects a long-press and drag of the input box toward a target. When the target corresponds to a participant, the input box transitions into a private composer and a private sub-thread is presented co-located with the timeline. Messages in the private sub-thread are encrypted using per-thread cryptographic keys issued and rotated by a key management service. A persistent notification bubble remains anchored in the timeline to identify the sub-thread and signal unread activity. When the input box is dropped onto a message authored by the user, the system enters an inline editing mode with auditability through a revision history data store.

### RELATED APPLICATIONS

This application a continuation-in-part of U.S. patent application Ser. No. 19/182,453, filed on Apr. 17, 2025, which is a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD OF INVENTION

The present disclosure relates to conversational user interfaces and, more specifically, to a morphable chat input component that can be repositioned over interface elements to invoke private-mode conversations, inline editing, and other context-specific functions.

### BACKGROUND

Conventional chat interfaces statically anchor the text input field below a message stream. Switching to a private conversation typically requires navigation away from the shared context. Likewise, editing a previously sent message often invokes a separate editor or dialog. These patterns introduce cognitive load, context loss, and additional taps/clicks, especially in fast-moving discussions or multi-party environments.

### SUMMARY

The present disclosure provides systems and methods for enabling context- preserving private messaging and inline editing within a conversational user interface. In one embodiment, a client device renders a chat interface including a message timeline, participant indicators, and a morphable input box. A gesture recognizer detects a long-press and drag of the morphable input box toward a target, and a mode/state engine applies policy rules to determine state transitions.

When the target corresponds to another participant, the morphable input box transitions into a private composer, and a private sub-thread is presented co-located with the main message timeline while preserving scroll position and context. The private sub-thread is encrypted using a per-thread cryptographic key that is issued and rotated by a key management service, and a persistent notification bubble is rendered in the chat interface to identify the private sub-thread and signal unread activity.

When the morphable input box is dropped onto a message authored by the initiating user, the system transitions into an inline editing state. The previously sent message is populated into the morphable input box, validated against policy constraints, and upon resubmission is updated in place with an edited indicator. A revision history data store maintains immutable records of original and revised message content, timestamps, and author identifiers, and may generate diff metadata for later retrieval.

In some embodiments, transitions among docked, dragging, private, and editing states are formally modeled in a state machine consumed by the mode/state engine. This approach provides deterministic, auditable, and policy-compliant state transitions that improve usability while maintaining compliance in regulated environments.

Additional embodiments extend the same interaction grammar to further contexts, including dragging the morphable input box onto a file bubble to open an annotation pane, onto a task card to append a note, or onto a form panel to pre-fill fields. By generalizing the morphable input box into a context-sensitive control, the disclosed system improves human-computer interaction by coupling conversational context with downstream workflows while preserving continuity of the chat experience.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating an exemplary system architecture for implementing a morphable input box within a conversational application, according to an implementation of the disclosure.

FIGS. 2A-2G are user interface diagrams illustrating exemplary interactions with the morphable input box, including private mode activation, inline editing, notification bubble display, and state continuity, according to an implementation of the disclosure.

FIG. 3 is a state machine diagram illustrating transitions among docked, dragging, private, and editing states of the morphable input box, according to an implementation of the disclosure.

FIG. 4 is a flow diagram illustrating a key management and encryption workflow for securing private sub-threads, according to an implementation of the disclosure.

FIGS. 5A-5D are user interface diagrams illustrating exemplary extensions of the morphable input box to file annotation, task cards, form panels, and private notes, according to an implementation of the disclosure.

FIG. 6 is a flow diagram illustrating an exemplary audit and revision workflow for edited messages and retrieval of diff metadata from a revision history data store, according to an implementation of the disclosure.

FIG. 7 illustrates an example computing system that may be used in implementing various features of embodiments of the disclosed technology.

Described herein are systems and methods for context-preserving private messaging and inline editing within a conversational interface. During a session, the system allows a user to initiate a private sub-thread by long-pressing and dragging a morphable input box onto a participant indicator or chat bubble, or to invoke inline editing by dropping the input box onto a previously sent message authored by the user. A gesture recognizer and mode/state engine manage deterministic transitions among docked, dragging, private, and editing states. Private sub-threads are secured using per-thread cryptographic keys issued and rotated by a key management service, while a persistent notification bubble remains visible in the main timeline to indicate sub-thread activity and unread messages. Edited messages are updated in place and logged in a revision history data store with immutable versioning and diff metadata. Extensions of the same drag-to-target grammar support additional contexts such as file annotation, task updates, or form pre-filling. Policy and compliance engines enforce permissions, retention, and audit logging. In this manner, the disclosed system improves security, usability, and workflow integration in chat-based environments by coupling conversational context with secure state management and auditable editing. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

In a present embodiment, a “Morpher” enables a chat interface in which the input box itself can be repositioned and transformed to perform context-specific functions. By dragging and dropping the input box onto participant indicators or message bubbles, the system seamlessly activates private sub-threads or inline editing modes without requiring navigation away from the main conversation. Private interactions are rendered in place with encryption, notification elements, and visual affordances, while edits are executed through real-time population of prior content into the input box and resubmission with revision tracking. By combining spatially intuitive gestures with secure state management, the Morpher provides a more fluid, efficient, and intelligent mechanism for initiating side conversations and correcting messages within ongoing chats.

As used herein, unless the context indicates otherwise: morphable input box (“Morpher”) means a text input component configured to switch location and mode based on drag-and-drop targets; private sub-thread means a secured, co-located conversation view limited to a subset of participants, rendered without navigating away from the main timeline; participant indicator means any UI element that represents a chat participant, including but not limited to a name label, avatar, presence chip, or a bubble authored by that participant.

### Conventional System Limitations

Conventional chat systems anchor the text input field in a fixed location beneath the message timeline. Initiating a private sidebar typically requires opening a new window or switching to a different thread, thereby disrupting spatial continuity and forcing users to navigate away from the shared context. Similarly, editing a previously sent message generally invokes a separate dialog or menu flow that interrupts the conversational timeline. These approaches increase interaction cost, introduce cognitive load, and reduce conversational fluidity, especially in fast-moving group discussions.

### Technical Improvements of the Present Disclosure

In contrast, the present embodiment introduces a morphable input box that can be held, dragged, and dropped onto interface targets to invoke context-specific modes directly within the primary chat view. Dragging the input box onto a participant indicator or message bubble initiates a private, co-located sub-thread secured by per-thread encryption keys and surfaced via a persistent notification element. Dragging onto the user's own bubble activates an inline editing mode that repopulates prior content into the morpher and updates the bubble in place with revision tracking. These improvements provide technical advantages by reducing state churn, preserving scroll position, maintaining co-located timelines, and integrating secure access controls at the UI layer. The result is a more efficient, technically robust conversational interface that leverages gesture recognition, finite state transitions, and adaptive visual feedback to deliver functionality not possible with conventional static input fields.

The following figure provides a high-level overview of the system architecture illustrating key modules and data flows between user devices and the server.

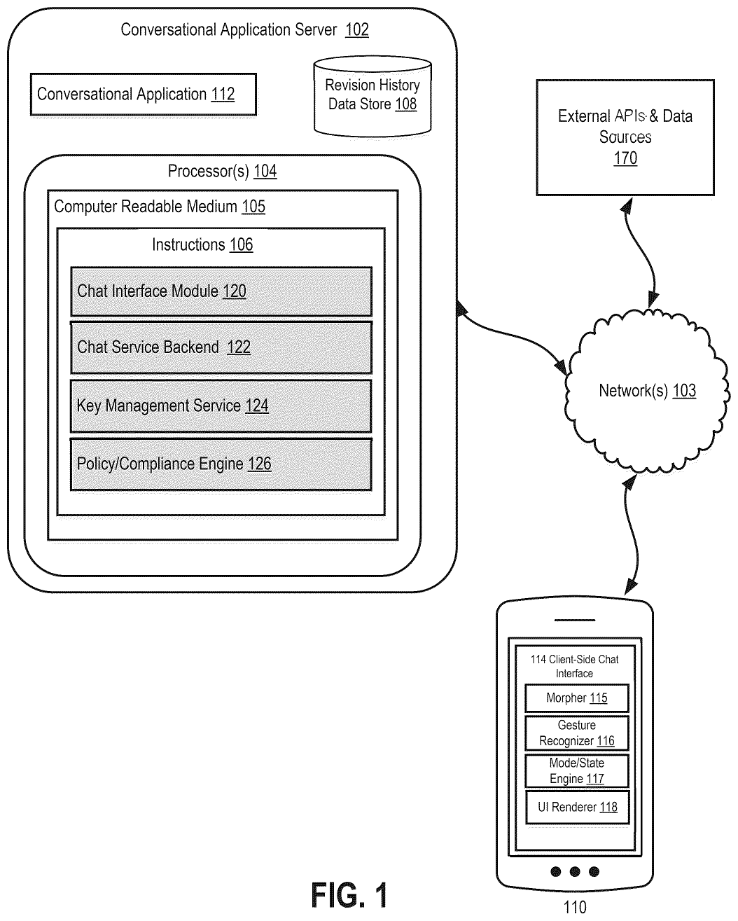

FIG. 1 illustrates an exemplary system architecture for implementing a morphable chat input within a conversational interface. The system includes a conversational application server 102 communicatively coupled to one or more client devices 110 via one or more networks 103. The conversational application server 102 comprises one or more processors 104, a computer readable medium 105 storing instructions 106, and associated components. The instructions 106 may include a chat interface module 120, a chat service backend 122, a key management service 124, and a policy/compliance engine 126. The conversational application server 102 further includes a conversational application 112 that coordinates interactions, and a revision history data store 108 for maintaining audit records and edited message versions.

The client device 110 executes a client-side chat interface 114 configured to present a message timeline and interactive elements. The client-side chat interface 114 includes a morpher 115 representing a morphable input box that can be dragged and dropped onto targets; a gesture recognizer 116 for detecting hold, drag, hover, and drop actions; a mode/state engine 117 for transitioning the morpher among docked, private, and editing states; and a UI renderer 118 for providing animations, adaptive highlights, explanatory captions, and notification elements.

The conversational application server 102 and the client device 110 communicate via the network(s) 103, and may additionally interface with external APIs and data sources 170 to support extended functions such as compliance logging, enterprise directory integration, or third-party knowledge queries. In operation, the architecture of FIG. 1 supports morphable input box interactions including drag-to-private and drag-to-edit, with secure key management, policy enforcement, and revision history tracking.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The disclosed system operates within a modular, service-oriented architecture designed to support morphable chat input, context-preserving private sub-threads, and secure inline editing in a conversational user interface. FIG. 1 provides a high-level overview, showing key functional modules and data flows between client devices and the server.

In an exemplary implementation, the system includes a conversational application server 102 configured to facilitate chat interactions while managing private sub-threads, enforcing edit policies, and providing compliance logging. The server 102 executes a conversational application 112 that orchestrates message flow, manages participant sessions, and invokes encryption, policy, and revision-tracking modules in real time. The server comprises one or more processors 104 and a computer-readable medium 105 that stores instructions 106 executable by the processors. These instructions include a chat interface module 120 configured to render messages, collect user inputs, expose controls for drag-and-drop actions, and coordinate the inline presentation of private threads and edited content.

In the following sections, each module is described in further detail with reference to specific functions, workflows, and interface elements.

A chat service backend 122 is configured to receive and persist messages, manage timelines, and spawn sub-thread containers in response to drag-to-private events. A key management service 124 generates and rotates per-thread encryption keys to secure private sub-threads, while a policy/compliance engine 126 enforces role-based permissions, time-boxing of edits, retention rules, and audit requirements. A revision history datastore 108 stores edited message versions, including metadata such as timestamps, author identifiers, and policy validation results.

User interaction with the system occurs via one or more client devices 110, which may include smartphones, tablets, or desktop clients equipped with communication software. Each client device 110 includes a display, a network interface, and a client-side chat interface 114 that presents the message timeline and the morphable input box. The chat interface 114 incorporates a morpher 115 for hold-and-drag interactions, a gesture recognizer 116 for detecting long-press, drag, hover, and drop events, a mode/state engine 117 implementing finite-state transitions among docked, private, and editing modes, and a UI renderer 118 that applies adaptive highlights, animations, captions, and notification elements.

In some implementations, the server 102 also accesses external APIs and data sources 170 to augment compliance, provide enriched context for editing, or integrate with enterprise systems such as directory services or knowledge bases. Such integrations may support additional workflows (e.g., annotating a file bubble, logging private notes to a CRM) while remaining subject to the access controls of the policy/compliance engine 126.

In certain embodiments, the system is deployed in a cloud environment with modular services exposed via secured APIs, enabling horizontal scalability, tenant isolation, and third-party integration. Local caching and gesture recognition are performed on device to reduce latency and preserve privacy, while server-side modules manage persistence, policy enforcement, encryption, and cross-device synchronization of private sub-threads and edit records.

The system further includes a revision history data store 108, which serves as a centralized repository for edited message versions, private sub-thread records, and compliance artifacts used by the conversational application 112. In a present embodiment, the revision history data store 108 maintains: (i) message revision records including original content, edited content, author identifiers, and timestamps; (ii) private sub-thread metadata comprising participant lists, initiation timestamps, last-message previews, and associated encryption key identifiers; (iii) audit data generated by the policy/compliance engine 126, such as access decisions, time limits on editing, and retention outcomes; and (iv) notification state data linked to private sub-threads, including unread counts, animation triggers, and visibility status across client devices.

The policy/compliance engine 126 governs read/write access to the revision history data store 108 and enforces tenant isolation, data minimization, and retention rules. In preferred embodiments, only derived metadata (e.g., diff summaries, key identifiers, unread flags) are persisted long-term, while raw conversation logs remain subject to tenant-scoped retention policies. The revision history data store 108 may also cache ephemeral state information, such as drag-and-drop initiation points and animation tokens, to support low-latency transitions across devices.

The revision history data store 108 may be deployed within the conversational application server 102 or distributed across a cloud infrastructure with encryption at rest, tenant isolation, and edge caches. Distributed deployment supports scalable access and real-time synchronization of edited message histories and private sub-thread notifications across multiple devices and sessions. Cached materials are limited to minimally necessary, non-sensitive extracts with a defined time-to-live, thereby maintaining performance without compromising privacy or compliance.

User interaction with the system occurs via one or more client computing devices 110, which may include smartphones, tablets, laptops, or desktop clients equipped with communication software. Each client computing device 110 includes a display, a network interface, and a client-side chat interface 114 for interacting with the conversational application 112. In a present embodiment, the client-side chat interface 114 incorporates: a morpher 115 representing a morphable input box; a gesture recognizer 116 configured to detect long-press, drag, hover, and drop actions; a mode/state engine 117 implementing finite-state transitions among docked, private, and editing modes; a UI renderer 118 responsible for adaptive highlights, explanatory captions, and animations; a notification bubble element (not illustrated) that persists within the interface to track private sub-threads with indicators such as initiation time, participants, and unread counts; and an accessibility and feedback layer (not illustrated) configured to provide haptic responses, ARIA announcements, and other accessibility cues during state transitions.

The client computing device 110 maintains local state information to preserve user experience during transient connectivity loss. For example, draft edits or private sub-thread initiation events may be temporarily stored on the device and later reconciled with the revision history data store 108 upon reconnection. In preferred embodiments, only minimally necessary metadata (e.g., draft identifiers, animation tokens, or unread counters) are cached locally, while raw encrypted message content is transmitted directly to the conversational application server 102.

In some embodiments, the system may be accessed through standard web browsers, mobile applications, or embedded widgets in third-party platforms, ensuring compatibility across deployment contexts. When accessed via a browser or third-party platform, the client computing device 110 maintains core Morpher functionality—including drag-to-private actions, inline editing, persistent notification bubbles, and accessibility feedback—within a sandboxed environment. This design allows morphable input workflows to be seamlessly integrated into existing collaboration tools, minimizing user friction and ensuring consistent behavior across devices and sessions.

In some embodiments, the system may access external APIs and data sources 170 to augment functionality related to private sub-threads, inline editing, or compliance workflows. These third-party resources may include enterprise directories, regulatory logging systems, task management tools, or knowledge bases that provide contextually relevant content. For example, when a user drags the morpher 115 onto a file bubble, an external annotation service may be invoked to attach metadata, or when a private sub-thread is created, a compliance logging API may be triggered to record access events.

Integration with external messaging platforms, such as Zoom, WhatsApp, or enterprise collaboration systems, may be facilitated via API-level connections, enabling users to benefit from Morpher's drag-to-private and drag-to-edit functionality even when operating outside of the native chat interface. These integrations may extend notification elements, preserve scroll position across embedded views, or synchronize revision histories across heterogeneous platforms.

Access to external APIs and data sources 170 is governed by the policy/compliance engine 126, least-privilege authentication, and data-minimization policies. In preferred embodiments, only derived metadata (e.g., audit records, encryption key identifiers, edit diffs) are exchanged, while raw conversation logs or sensitive user identifiers remain tenant-scoped and encrypted within the conversational application server 102. This approach ensures that external integrations enhance functionality without compromising privacy, security, or regulatory compliance.

In some embodiments, the system is deployed in a cloud environment with modular services exposed via secured APIs, enabling horizontal scalability, tenant isolation, and third-party integration. Client-side modules such as the morpher 115, gesture recognizer 116, mode/state engine 117, and UI renderer 118 execute locally to ensure low-latency interaction, haptic feedback, and accessible state transitions, while server-side modules manage persistence, encryption, compliance, and revision history across sessions. The architecture supports cross-device synchronization, ensuring that private sub-threads and edited message records remain consistent whether a user interacts via a mobile application, desktop client, or embedded widget. By distributing inference and caching between the client and server, the system achieves both responsiveness and policy-governed data integrity in a manner scalable to large multi-tenant deployments.

FIG. 1 illustrates an exemplary system architecture for implementing a morphable chat input within a conversational interface. The system includes a conversational application server 102 communicatively coupled to one or more client computing devices 110 via one or more networks 103. The conversational application server 102 comprises one or more processors 104 and a computer-readable medium 105 storing instructions 106 that, when executed, configure the server to provide chat interactions, private sub-threads, and inline editing.

In the embodiment shown, the instructions 106 implement a chat interface module 120, a chat service backend 122, a key management service 124, and a policy/compliance engine 126. The conversational application 112 orchestrates overall session flow, manages participant states, and invokes the modules in real time. A revision history data store 108 maintains records of private sub-threads, message edits, and compliance metadata for later retrieval and audit.

The client computing device 110 executes a client-side chat interface 114 configured to display message timelines and handle morphable input interactions. The client-side chat interface 114 incorporates a morpher 115 (the morphable input box), a gesture recognizer 116 for detecting drag-and-drop operations, a mode/state engine 117 for transitioning the morpher among docked, private, and editing states, and a UI renderer 118 that applies highlights, animations, and explanatory captions. The client-side chat interface 114 may also include a notification bubble element (not illustrated) for persistent private-thread tracking and an accessibility and feedback layer (not illustrated) providing haptics and ARIA announcements.

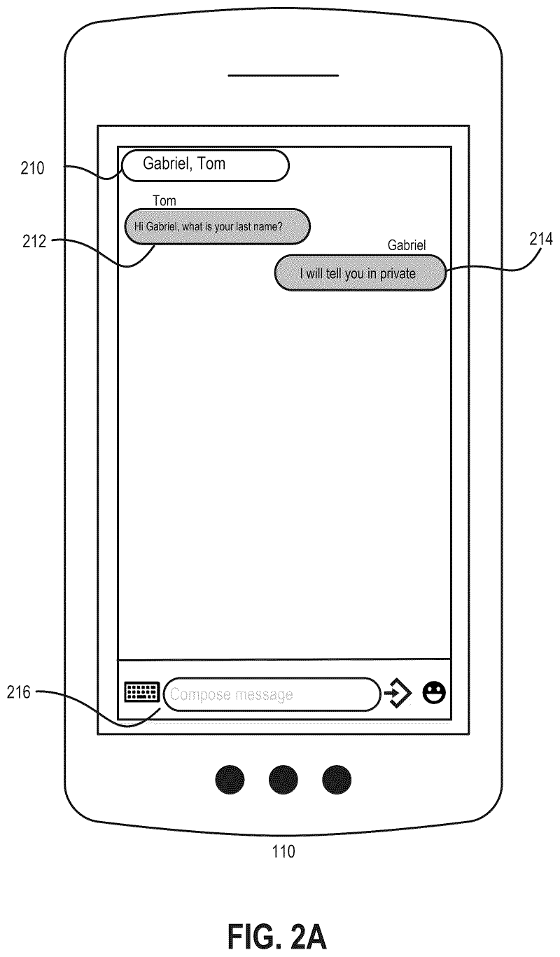

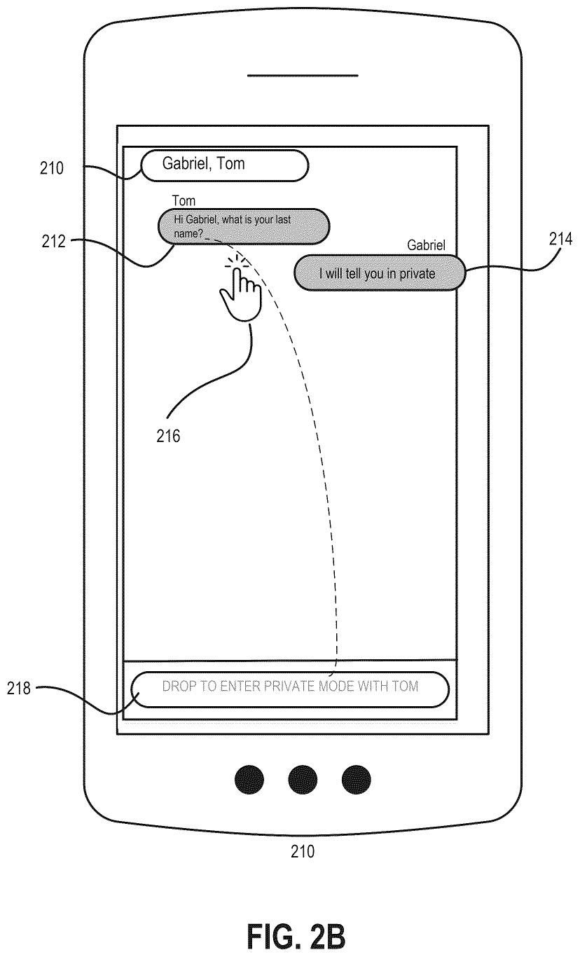

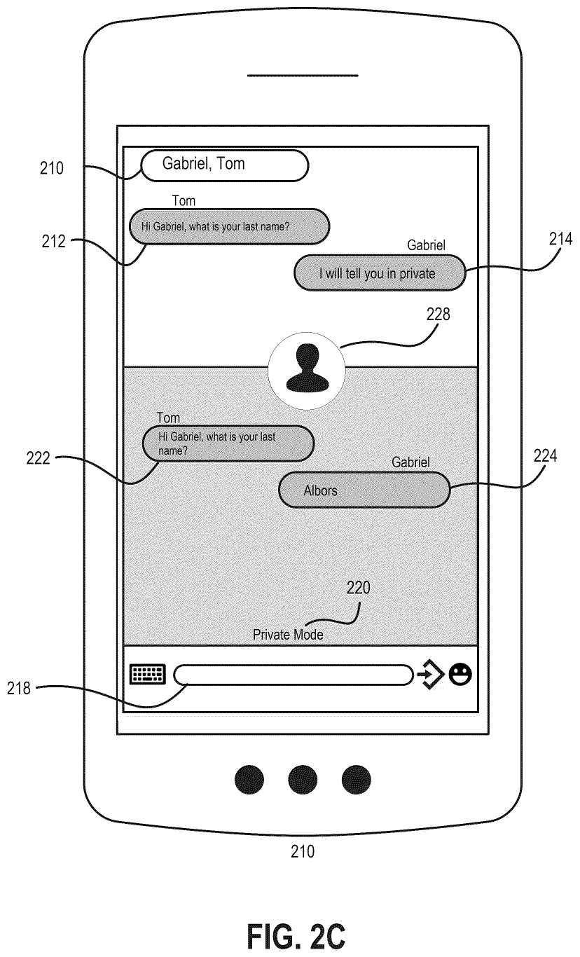

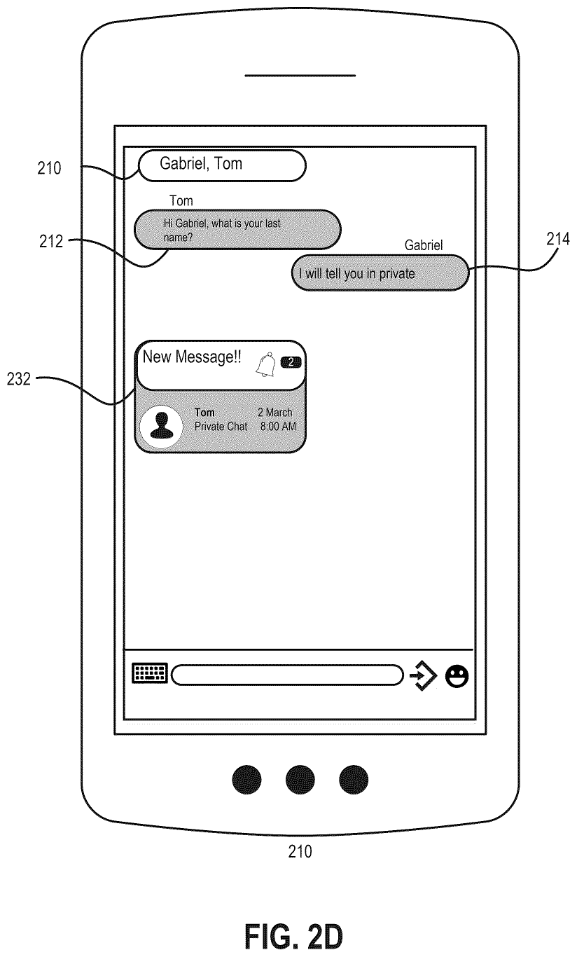

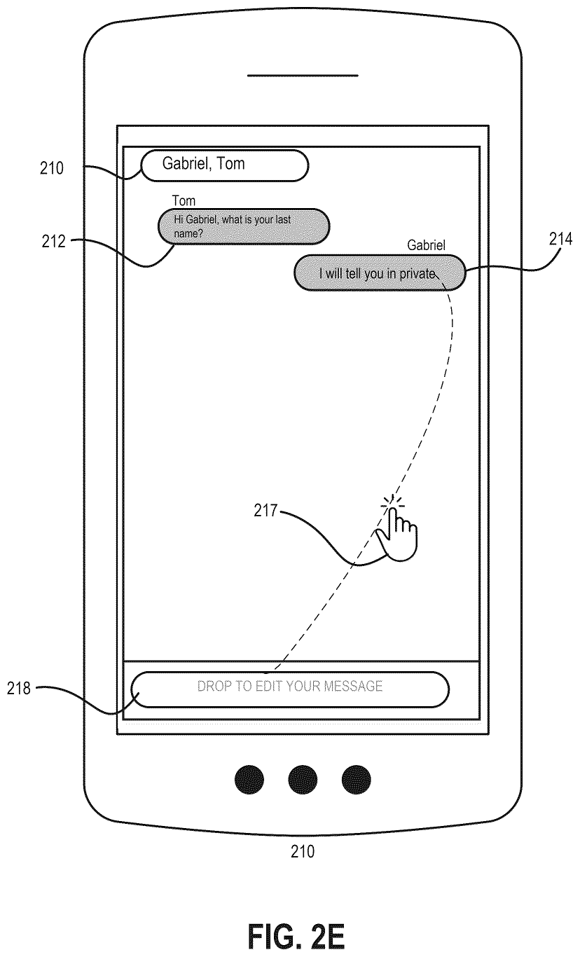

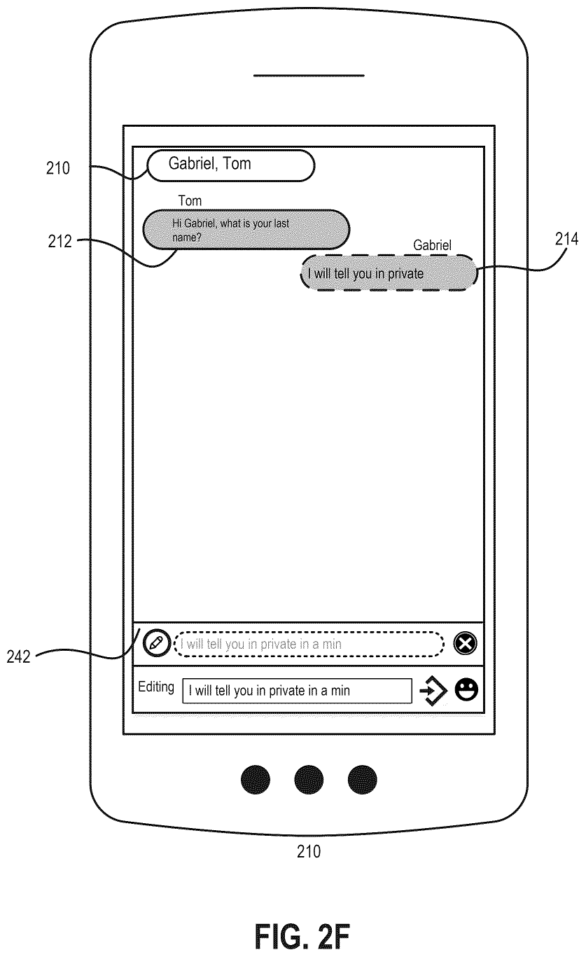

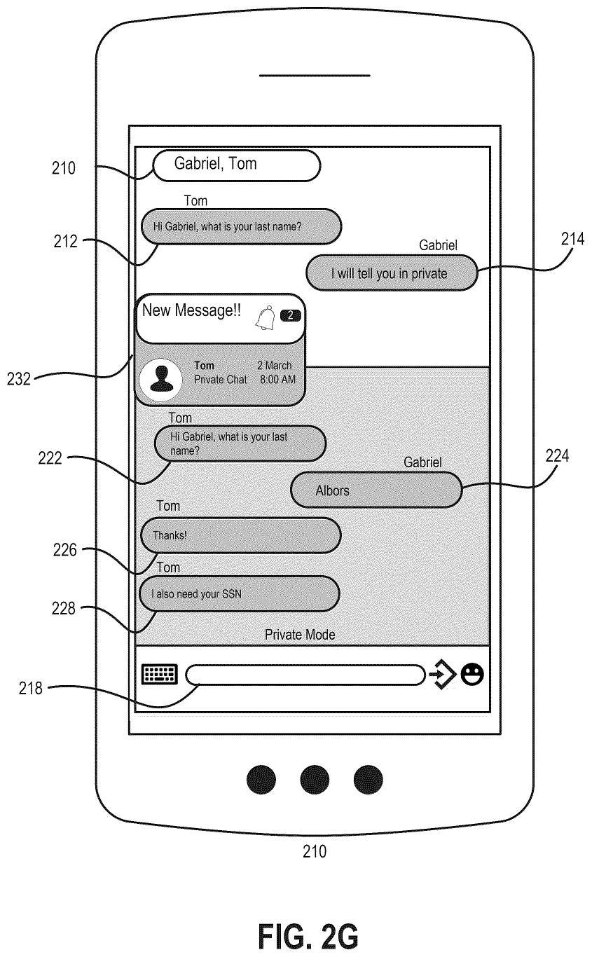

In operation, the gesture recognizer 116 and mode/state engine 117 (FIGS. 2A-2E) handle drag-and-drop of the morpher 115 onto participant indicators or message bubbles. The UI renderer 118 applies adaptive highlights and explanatory strips (FIGS. 2B-2C), while the chat service backend 122 spawns private sub-thread containers (FIGS. 2C, 2G). The key management service 124 secures private threads with per-thread encryption keys, and the policy/compliance engine 126 enforces permissions, retention, and legal-hold rules. The revision history data store 108 logs message edits initiated by dropping the morpher on a user-authored bubble (FIGS. 2E-2F). Notification bubble 232 (FIGS. 2D, 2G) and accessibility feedback ensure ongoing visibility and inclusivity of the private-thread state.

FIG. 2A illustrates an example chat interface rendered on a client computing device 110. The interface displays a group conversation including participant indicators 210 and chat bubbles 212, 214. A morphable input box 216 is anchored at the bottom of the interface in its default docked position, enabling the user to compose new messages.

FIG. 2B illustrates the initiation of a private mode sequence. In this example, the user drags the morphable input box 216 toward a chat bubble 212 associated with another participant. As the input box approaches the target, a prompt region 218 is displayed with explanatory text (e.g., “Drop to enter private mode with Tom”). The target bubble 212 may also highlight or animate, indicating that it is an eligible drop target.

FIG. 2C illustrates the chat interface after activation of a private sub-thread. The interface presents a dedicated private mode region 220 distinguished by a modified background color. Within this region, new message bubbles 222, 224 are displayed exclusively between the initiating user and the selected participant. A private-mode indicator 228, such as a lock icon or participant avatar, reinforces that the conversation is limited to the designated participants. The morphable input box 218 is re-rendered in private mode, and any new messages entered therein are transmitted using secure, per-thread encryption keys.

FIG. 2D illustrates the presentation of a persistent notification bubble 232 associated with the private sub-thread. The notification bubble 232 appears in the main conversation timeline and provides metadata such as the participant's name, the initiation time, and a last-message preview. The notification bubble 232 may animate, pulse, or otherwise highlight when new unread messages are received in the private sub-thread.

FIG. 2E illustrates a drag-to-edit sequence. The user drags the morphable input box 216 along path 217 toward the user's own previously sent chat bubble 214. As the drag operation approaches the target, a prompt region 218 appears, instructing the user to drop the morpher to initiate message editing.

As the drag operation approaches the target, a prompt region 218 appears, instructing the user to drop the morpher to initiate message editing. In some embodiments, the gesture recognizer 116 detects the drag path 217, the target bubble 214 highlights as a drop zone, and the UI renderer 118 provides an explanatory strip such as “Drop to edit message.”

FIG. 2F illustrates the chat interface in an inline editing mode after the morpher has been dropped on the user's own message bubble 214. In this state, the prior message content is loaded into the morphable input box 242 for real-time editing. Upon submission, the updated message replaces the original bubble 214 in the conversation timeline, optionally tagged with an “edited” indicator or badge. Revision data is logged in the revision history data store 108 to maintain auditability.

In some embodiments, revision data is logged in the revision history data store 108 to maintain auditability. In some embodiments, the inline editing interface further displays the prior message content within the morpher 242 for revision and re-renders the updated bubble 214 with an “edited” badge or tooltip. The tooltip may reveal a diff or summary of prior versions, while the revision history data store 108 preserves immutable records for compliance.

FIG. 2G illustrates the ongoing state of a private sub-thread rendered in place within the primary chat interface. The interface displays the main conversation timeline with participant indicators 210 and group bubbles 212, 214, alongside a private mode region 220 distinguished by a shaded background. Within the private mode region 220, new message bubbles 222, 224, and 226 are exchanged exclusively between the initiating user and the selected participant. A persistent notification bubble 232 remains visible in the main view, providing metadata such as the participant's name, timestamp, and a last-message preview. The notification bubble 232 may animate or pulse to indicate unread activity. The morphable input box 218 remains available at the bottom of the screen, configured for private-mode composition with secure per-thread encryption. In a present embodiment, a client device 110 renders a chat interface comprising: (i) a message timeline with bubbles (see FIG. 2A, 212, 214); (ii) participant indicators such as names or avatars (FIG. 2A, 210); (iii) a morphable input box 216 anchored by default to a dock region (FIG. 2A); and (iv) a state manager and gesture recognizer 116. The morphable input box 216 (“morpher”) supports pointer or touch operations including hold-to-unlock, drag, hover-over target detection, and drop. A client-side mode/state engine 117 inspects the drop target selector and applies a policy corresponding to private_mode, edit_own_message, or other_context_action.

In some embodiments, the morphable input box 218 remains available at the bottom of the screen, configured for private-mode composition with secure per-thread encryption. In some embodiments, the notification bubble 232 also provides metadata such as a participant list, initiation timestamp, and a last-message preview. The notification bubble 232 may animate, pulse, or expand when hovered to show additional context while maintaining its anchored position within the main conversation timeline.

In a present embodiment, a client device 110 (FIG. 1) renders a chat interface comprising: (i) a message timeline with bubbles (FIG. 2A, 212, 214); (ii) participant indicators such as names or avatars (FIG. 2A, 210); (iii) a morphable input box 216 anchored by default to a dock region (FIG. 2A); and (iv) a state manager and gesture recognizer 116 (FIG. 1). The morphable input box 216 (“morpher”) supports pointer or touch operations including hold-to-unlock, drag, hover-over target detection, and drop. A client-side mode/state engine 117 (FIG. 1) inspects the drop target selector and applies a policy corresponding to private_mode, edit_own_message, or other_context_action.

When the morpher 216 is dropped on a participant name, avatar, or chat bubble (FIG. 2B, 212), the UI renderer 118 (FIG. 1) applies an adaptive highlight to the target (e.g., color shift or micro-animation) and transitions the morpher 216 into a private composer. The system spawns a private sub-thread container 220 co-located with the main conversation (FIG. 2C), preserving scroll position and context. The private sub-thread is end-to-end encrypted between the initiating user and the selected participant(s). A persistent notification bubble 232 remains visible in the main view (FIG. 2D, FIG. 2G), showing the private thread's participants, initiation timestamp, and a last-message preview. The notification bubble 232 may animate (e.g., subtle pulse) upon receipt of unread private messages. Policy features may include permissions (e.g., administrator-only private threads, ephemeral retention), compliance logging, and presence signals such as typing indicators visible only to private-thread participants.

When the morpher 216 is dropped on the user's own previously sent chat bubble 214 (FIG. 2E), the system transitions to an edit state. In this state, the system fetches the prior message content and populates it into the morpher 242 (FIG. 2F), enabling real-time editing with inline validations such as policy checks, profanity filters, or structured metadata constraints. Upon submission, the message bubble 214 is updated in place with an “edited” badge and optionally a diff tooltip. A revision history is retained in the revision history data store 108 (FIG. 1) with fields such as time, author, and policy results. The edit state may be time-bounded or role-bounded depending on compliance settings.

Animated affordances communicate state transitions to improve user understanding. For example, the target bubble 212 may briefly highlight (FIG. 2B), the morpher 216 may ripple or resize (FIG. 2B-2C), and an explanatory strip may appear beneath the input box with context-specific text such as “Private chat with Alex activated” or “Editing your message.” These animations and captions are generated by the UI renderer 118 (FIG. 1) and may be supplemented with haptic or accessibility feedback (not illustrated).

Private sub-threads are transmitted via secure channels with per-thread keys issued by the key management service 124 (FIG. 1). The policy/compliance engine 126 (FIG. 1) enforces access controls, key rotation, and retention or legal-hold rules. Edited messages produce immutable audit events written to the revision history data store 108 (FIG. 1; FIG. 2F). Policies may further restrict drag-to-private actions in regulated channels, substituting a compliant alternative such as a private note visible only to the initiating user.

The interaction grammar enabled by the morpher 216 may be extended to additional targets. For example, dragging onto a file bubble may open an annotation pane; dropping onto a task card may append a private note; dropping onto a form panel may pre-fill one or more fields; or dropping onto a knowledge result may refine a query. These extensions apply the same gesture recognizer 116, mode/state engine 117, and UI renderer 118 (FIG. 1) to broaden the scope of context-specific actions available in the chat interface (see also FIGS. 2A-2G for representative private and edit interactions).

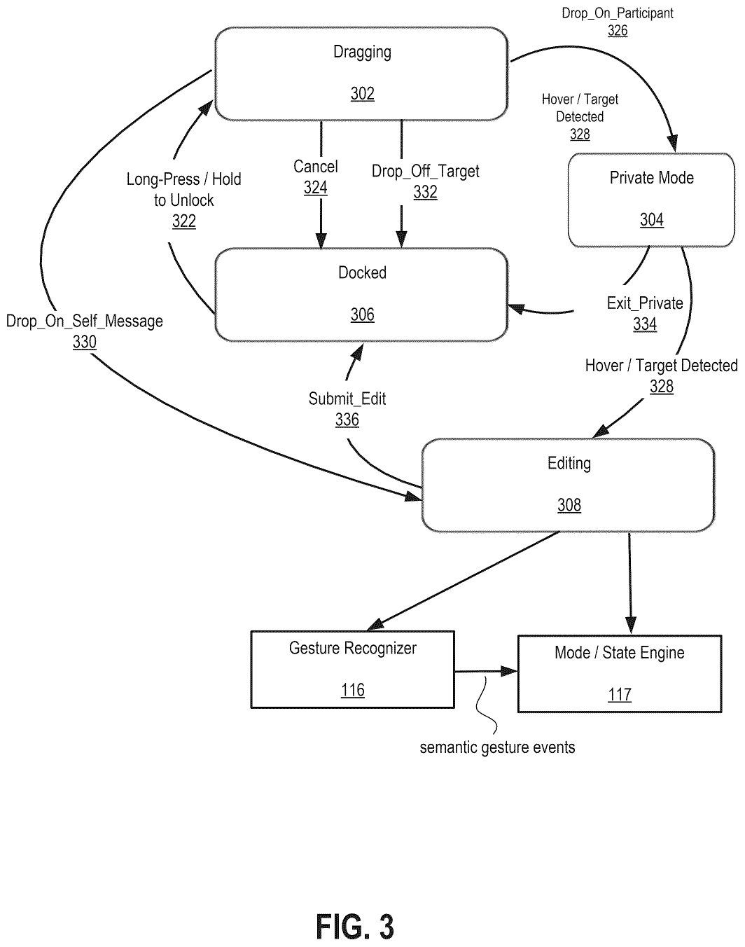

FIG. 3 illustrates a state machine diagram showing transitions among docked, dragging, private, and editing modes of the morphable input box. In the embodiment shown, the input box begins in a docked state 306, from which a long-press or hold gesture 322 originating at the morpher 216 triggers a transition to a dragging state 302. While dragging, the gesture recognizer 116 interprets raw touch or pointer inputs and emits semantic events to the mode/state engine 117, which applies state-transition policies. For example, detection of a hover over a participant indicator (HOVER_TARGET_DETECTED 328) followed by a drop on that participant (DROP_ON_PARTICIPANT 326) causes a transition to a private mode 304. Detection of a hover over the user's own bubble followed by a drop (DROP_ON_SELF_MESSAGE 330) causes a transition to an editing state 308. If the input is released off-target (DROP_OFF_TARGET 332) or canceled (CANCEL 324), the state machine returns to docked 306. From private mode 304, the user may exit back to docked via an EXIT_PRIVATE 334 event. From editing 308, submission of an edit (SUBMIT_EDIT 336) or cancellation of the edit (CANCEL_EDIT, not illustrated) also returns the system to docked 306. The state machine thus provides a formal model for gesture-driven interactions, with the gesture recognizer 116 and mode/state engine 117 cooperating to ensure deterministic and policy-compliant transitions.

The state machine of FIG. 3 further illustrates that the disclosed interactions are not abstract ideas but instead are implemented as concrete, computer-executed state transitions enforced by the gesture recognizer 116 and mode/state engine 117. Unlike conventional chat interfaces that treat drag or long-press actions as cosmetic inputs, the present embodiment defines deterministic pathways among distinct operational states (docked, dragging, private, editing) with explicit entry and exit conditions. These transitions preserve scroll position, enforce per-thread encryption policies, and maintain revision histories through the revision history data store 108. As such, the state machine reflects a technological improvement in human-computer interaction, enabling context-sensitive behaviors that are formally modeled, auditable, and integrated into secure backend services, rather than generic human activity management.

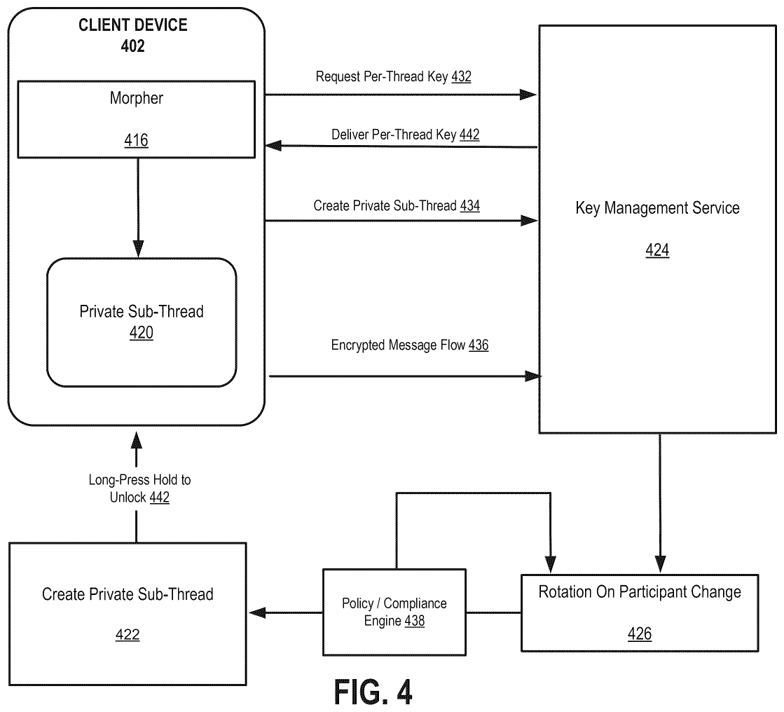

FIG. 4 illustrates an exemplary key-management workflow for securing private sub-threads. A client device 402 includes a morpher 416 that, upon a long-press hold gesture 422, initiates creation of a private sub-thread 420. In response, the client device 402 transmits a request for a per-thread key 432 to a key management service (KMS) 424, and issues a create private sub-thread instruction 434 to the server. The KMS 424 delivers a per-thread key 442 bound to the authorized participant set, enabling an encrypted message flow 436 for the private sub-thread 420. When a participant changes, a rotation service 426 rotates keys and re-issues them to eligible clients. A policy/compliance engine 438 validates thread creation, key issuance, and rotation events, enforcing organizational permissions, retention limits, and legal-hold requirements.

The workflow of FIG. 4 demonstrates a concrete computer-implemented improvement over conventional chat systems by provisioning per-thread cryptographic keys tied to the private sub-thread's participant set and automatically rotating those keys upon membership change. This lifecycle—request, issuance, encrypted transport, and rotation—occurs under explicit policy control (engine 438), thereby integrating secure key management into the UI-driven interaction (morpher 416 and private sub-thread 420). The result is a technical enhancement to confidentiality and access control that is tightly coupled to the state of the conversation and not merely a generic use of encryption.

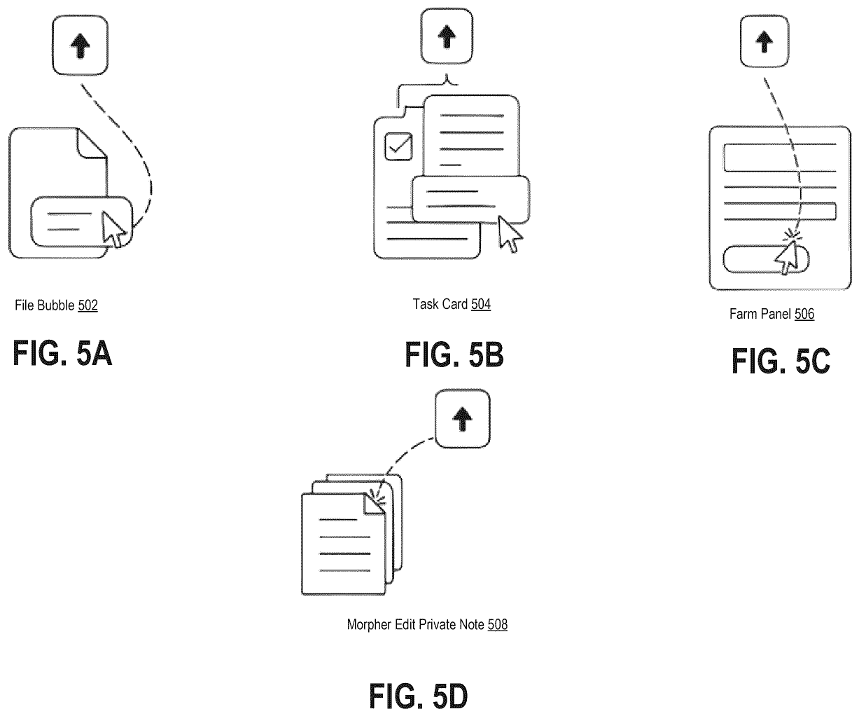

FIGS. 5A-5D illustrate exemplary extensions of the morphable input box to targets beyond private messaging and editing.

FIG. 5A shows a file bubble 502 receiving a drag-and-drop of the morpher. In this embodiment, the morpher opens an annotation pane linked to the file, enabling users to append private or contextual notes without leaving the chat timeline.

FIG. 5B shows a task card 504 as the drop target. When the morpher is released on the task card 504, the system appends a private note or comment to the task record, integrating chat-based input with task management workflows.

FIG. 5C shows a form panel 506 receiving the morpher drop. Here, the prior content of the morpher is used to pre-fill one or more fields of the form, reducing redundant input and enabling conversational completion of structured forms.

FIG. 5D illustrates the morpher being dropped to generate a private note 508. In this case, the morpher's contents are stored in a secure, user-specific notebook accessible within the chat application, allowing users to capture private notes without exposing them to other participants.

These extension examples demonstrate that the same drag-to-target interaction grammar generalizes across multiple contexts, with the gesture recognizer 116 and mode/state engine 117 (FIG. 1) managing transitions into specialized actions. Each extension preserves scroll position and conversational continuity while integrating with external modules such as file repositories, task managers, and form engines.

The interaction patterns of FIGS. 5A-5D illustrate a concrete computer-implemented improvement by extending the morphable input box into diverse application contexts. Conventional chat systems treat the input field as a static text composer, while the present embodiment generalizes the input field into a stateful UI control capable of invoking structured actions when dropped on recognized targets such as file bubbles 502, task cards 504, form panels 506, or private notes 508. These interactions are implemented through the gesture recognizer 116 and mode/state engine 117 (FIG. 1), which deterministically trigger state transitions and API calls to external services. As such, the disclosed approach improves computer functionality by reducing redundant data entry, preserving scroll position, and tightly coupling conversation context with downstream workflows, rather than merely organizing human activity.

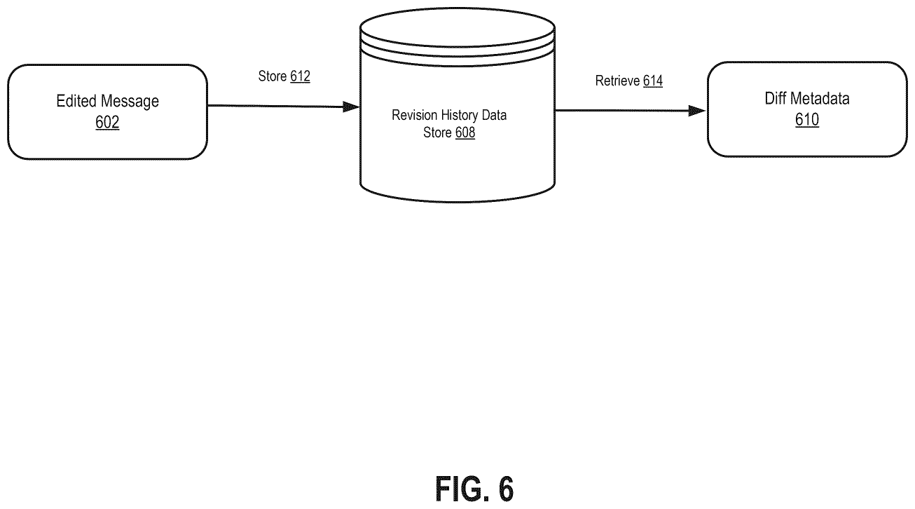

FIG. 6 illustrates an exemplary workflow for revision history management of edited messages. When a user initiates an inline edit, the edited message 602 is stored 612 in a revision history data store 608. The revision history data store 608 maintains immutable records of prior versions, including author identifiers, timestamps, and policy validation results. Upon request, the system may retrieve 614 a record from the revision history data store 608 together with diff metadata 610. The diff metadata 610 may include a summary of differences between message versions, such as insertions, deletions, or substitutions, and may be rendered as a tooltip, badge, or audit report.

In some embodiments, the revision history data store 608 enforces role-based access controls to ensure that only authorized users can retrieve or view certain edit histories. The store may also apply data minimization policies such that only derived features (e.g., diff summaries, timestamps) are exposed, while raw message logs are retained under tenant-specific retention rules.

The workflow of FIG. 6 demonstrates a concrete computer-implemented improvement by providing structured, machine-readable revision histories that enable auditability and compliance tracking within a conversational interface. Unlike conventional chat platforms that overwrite or discard edited content, the present system persists edits with immutable metadata, allowing regulated industries to satisfy retention requirements and enabling end users to visualize message differences in real time. This improves the technical functioning of the chat application by coupling editing features with data integrity, retrieval efficiency, and compliance enforcement, rather than merely organizing human communication.

In some embodiments, the system implements a per-thread key management workflow to secure private sub-threads. When a user initiates a private mode via a long-press and drag gesture on the morpher, the client device transmits a request to the key management service for issuance of a per-thread cryptographic key. The key management service provisions a unique encryption key bound to the participant set of the private sub-thread and returns the key to the requesting client. Messages transmitted within the private sub-thread are encrypted using this per-thread key before being forwarded to the server or other participants.

When the participant set of a private sub-thread changes, the key management service automatically rotates the encryption key, invalidating the prior key and issuing a replacement to the updated set of authorized clients. A policy and compliance engine validates these key issuance and rotation events, ensuring that access is limited to authorized users, retention and expiration rules are enforced, and audit logs are generated for compliance purposes. In some embodiments, the rotation process is transparent to users and does not interrupt ongoing chat interactions, as the client devices seamlessly update their local state with the new key.

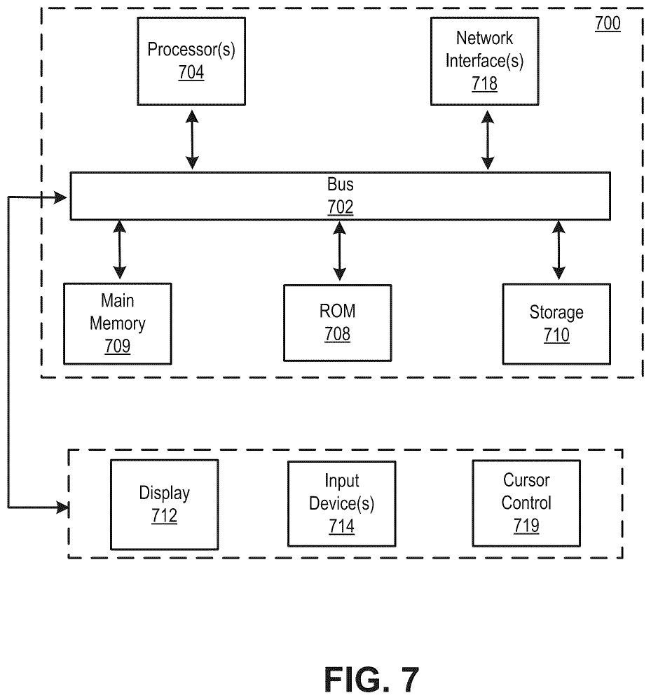

This workflow represents a technical improvement over conventional chat systems by tightly coupling key lifecycle management to the interaction state of the morphable input box. By linking encryption key provisioning and rotation to specific UI events (e.g., drag-to-private initiation, participant change), the system ensures that confidentiality and integrity are enforced at the level of conversational context. This integration of cryptographic key management with front-end gesture interactions provides stronger data protection, policy enforcement, and auditability than generic transport-layer encryption approaches.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 7. Various embodiments are described in terms of this example computing module 700. After reading this description, it will become apparent to a person skilled in the relevant art how to implement the technology using other logical circuits or architectures.

FIG. 7 illustrates an example computing module 700, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 1. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special- purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally. The bus 702 may also be connected to other components such as a display 712, input devices 714, or cursor control 716 to help facilitate interaction and communications between the processor and/or other components of the computing module 700.

Computing module 700 might also include one or more memory modules, simply referred to herein as main memory 706. For example, preferably random-access memory (RAM) or other dynamic memory might be used for storing information and instructions to be executed by processor 704. Main memory 706 might also be used for storing temporary variables or other intermediate information during execution of instructions to be executed by processor 704. Computing module 700 might likewise include a read only memory (“ROM”) 708 or other static storage device 710 coupled to bus 702 for storing static information and instructions for processor 704.

Computing module 700 might also include one or more various forms of information storage devices 710, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 710 might include other similar instrumentalities for allowing computer programs or other instructions or data to be loaded into computing module 700. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 700.

Computing module 700 might also include a communications interface or network interface(s) 718. Communications or network interface(s) interface 718 might be used to allow software and data to be transferred between computing module 700 and external devices. Examples of communications interface or network interface(s) 718 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 718 might typically be carried on signals, which can be electronic, electromagnetic (which includes optical) or other signals capable of being exchanged by a given communications interface. These signals might be provided to communications interface 718 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 706, ROM 708, and storage unit interface 710. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for context-preserving private messaging and inline editing in a conversational user interface, comprising:
rendering, on a client device, a chat interface including a message timeline, participant indicators, and a morphable input box;
detecting, by a gesture recognizer, a long-press on the morphable input box and a drag toward a target;
in response to detecting a drop on a first target corresponding to a participant, transitioning the morphable input box into a private-conversation composer;
presenting, within the chat interface and without navigating away from the message timeline, a private sub-thread between a primary user and the participant;
encrypting messages of the private sub-thread using a per-thread cryptographic key; and
rendering a persistent notification element in the chat interface that identifies the private sub-thread and is updated upon receipt of an unread private message.

2. The method of claim 1, further comprising applying an adaptive visual highlight to the first target during hover and displaying an explanatory caption proximate to the morphable input box indicating activation of private mode.

3. The method of claim 1, wherein encrypting comprises requesting issuance of the per-thread cryptographic key from a key management service and receiving a key bound to an authorized participant set of the private sub-thread.

4. The method of claim 3, further comprising rotating the per-thread cryptographic key responsive to a change in the authorized participant set and re-issuing a replacement key to authorized clients.

5. The method of claim 1, wherein the persistent notification element animates when an unread message is detected and displays at least one of: a last-message preview, a participant list, or an initiation timestamp.

6. The method of claim 1, further comprising detecting a drop of the morphable input box on a second target corresponding to a previously sent message authored by the primary user and, in response, transitioning the morphable input box into an editing state.

7. The method of claim 6, further comprising populating content of the previously sent message into the morphable input box, enforcing one or more content validations during editing, and upon submission updating the previously sent message in place with an edited indicator.

8. The method of claim 7, further comprising storing, in a revision history data store, immutable records including the original content, revised content, timestamps, and author identifiers, and generating diff metadata for later retrieval.

9. The method of claim 1, wherein transitions among docked, dragging, private, and editing states are determined by a mode/state engine that consumes semantic gesture events emitted by the gesture recognizer.

10. The method of claim 1, wherein presenting the private sub-thread preserves a scroll position of the message timeline and renders the private sub-thread co-located with the message timeline.

11. A computer-implemented system for context-preserving private messaging and inline editing in a conversational interface, comprising:
one or more processors; and
a non-transitory computer-readable medium storing instructions that, when executed by the one or more processors, cause the system to:
render, on a client device, a chat interface including a message timeline, participant indicators, and a morphable input box;
detect, by a gesture recognizer, a long-press on the morphable input box and a drag toward a target;
in response to detecting a drop on a first target corresponding to a participant, transition the morphable input box into a private-conversation composer;
present, within the chat interface and without navigating away from the message timeline, a private sub-thread between a primary user and the participant;
encrypt messages of the private sub-thread using a per-thread cryptographic key; and
render a persistent notification element in the chat interface that identifies the private sub-thread and is updated upon receipt of an unread private message.

12. The system of claim 11, wherein the gesture recognizer is further configured to detect hover over the first target and the system applies an adaptive highlight and caption to indicate activation of private mode.

13. The system of claim 11, wherein the non-transitory computer-readable medium further stores instructions to request issuance of the per-thread cryptographic key from a key management service and to receive a key bound to an authorized participant set of the private sub-thread.

14. The system of claim 13, wherein the key management service is further configured to rotate the per-thread cryptographic key responsive to a participant change and re-issue a replacement key to authorized clients.

15. The system of claim 11, wherein the persistent notification element animates to indicate unread private messages and further displays a last-message preview, a participant list, and an initiation timestamp.

16. The system of claim 11, wherein the non-transitory computer-readable medium further stores instructions to detect a drop of the morphable input box on a second target corresponding to a message authored by the primary user and, in response, transition the morphable input box into an editing state.

17. The system of claim 16, wherein the system is configured to populate content of the message authored by the primary user into the morphable input box, apply content validations during editing, and update the message in place with an edited indicator upon submission.

18. The system of claim 17, wherein the system further comprises a revision history data store configured to store immutable records including the original content, revised content, timestamps, and author identifiers, and to provide diff metadata for retrieval.

19. The system of claim 11, wherein the mode/state engine is configured to consume semantic gesture events emitted by the gesture recognizer, the semantic gesture events including at least LONG_PRESS_START, HOVER_TARGET_DETECTED, DROP_ON_PARTICIPANT, DROP_ON_SELF_MESSAGE, DROP_OFF_TARGET, and CANCEL.

20. The system of claim 11, wherein the system further comprises a policy/compliance engine configured to enforce at least one of: role-based permission to initiate private sub-threads, time-bounded editing windows, retention or legal-hold rules, or substitution of a compliant alternative workflow when private mode is unavailable.
